(19) United States
(12) Patent Application Publication
(10) Pub. No.: US 2005/0248532 A1
(43) Pub. Date: Nov. 10, 2005

(54) Apparatus and method for implementing mouse function and scanner function alternatively

(76) Inventors: Young-Chan Moon, Seoul (KR); Yang-keun Yu, Pacifica, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/512,402

(22) PCT Filed: Apr. 22, 2003
(86) PCT No.: PCT/KR03/00816

§ 371 Date: Jun. 20, 2005

(30) Foreign Application Priority Data
Apr. 25, 2002 (KR) 10-2002-0022778

(51) Int. Cl. G09G 5/08

(52) U.S. Cl. 345/163

(57) ABSTRACT

The X, Y axes transition of position of apparatus according to the present invention is detected by employing portion of section of image input device, information concerning said detected X, Y axes transition of position is forwarded to a computer, and thus the apparatus of the present invention can be operated by a mouse. Also, image detected together with the information concerning X, Y axes transition of position of the apparatus is delivered to a computer or other device so that the apparatus of the present invention can be operated as a scanner, and the shaking of image can be adjusted or compensated. Accordingly, an apparatus for implementing mouse function and scanner function alternatively is provided.

### TECHNICAL FIELD

The present invention is directed to an apparatus for implementing mouse function and scanner function alternatively and the method thereon and more particularly, an apparatus for implementing mouse function and scanner function alternatively and the method thereof which detects the X, Y axes transition of position of an apparatus according to the present invention employing portions of section of the input device of a scanner, forwards the detected information regarding X, Y axes transition of position of the apparatus to a computer for the apparatus of the present invention to be operated by a mouse, and delivers the detected images together with information regarding X, Y axes transition of position of the apparatus to a computer or other device for the apparatus of the present invention to be operated by a scanner.

### DESCRIPTION OF THE RELATED ART

Scanners generally employ charge-coupled device (CCD) or contact image sensor (CIS) to sequentially read various images printed on the surface and to sequentially store image in units of lines in a memory device so as to obtain image of one page. The picture obtained as such is transmitted to a computer through a cable to be outputted on the screen or to be printed out by a printer.

Such scanner detects matters that move CCD and CIS in a steady speed and light reflected from the surface in order to obtain accurate picture, and it is important to accurately detect voltage generated from CCD and CIS due to the above detection.

The scanner invented conventionally are in various sizes, but are installed with a structure that can move steadily because it is basically important to steadily move CCD or CIS which are constitutional elements of the scanner with regard to the document or to steadily move the document with regard to CCD or CIS. In this regard, the structure enabling steady move may employ a roller or a method to move a fixed post, etc.

Mouse can be classified into a ball mouse or an optical mouse. The ball mouse is a device for detecting user's movement by changing mechanical movement into electrical signals to forward the relative amount of change toward X axis and Y axis for the user to be able to place the pointer to his/her desired position. On the other hand, the optical mouse is a device for detecting amount of light reflected from the surface, and detecting the movement of spot (a flaw or texture of paper) on the surface based on the aforementioned detection to forward the relative amount of movement toward X axis and Y axis to a computer for the user to be able to place the pointer to his/her desired position.

The conventional scanner and the optical mouse have the same characteristic in the aspect that they detect image of the surface. However, the scanner requires a structure enabling CCD and CIS which are detectors of the scanner to steadily move at a fixed speed in a straight line, whereas the mouse has a contradictory characteristic to the scanner wherein the user freely moves toward X, Y axes, and the speed of the movement is not fixed. Thus, it is difficult to manufacture an apparatus that has a mouse and a scanner built in one. Physically, it is possible to manufacture an apparatus built in with a mouse and a scanner together, but such apparatus renders a problem wherein the apparatus will have a very big size, and it will be inconvenient to use when using the structure of each device as they are.

### SUMMARY OF THE INVENTION

An object of the present invention is to solve the aforementioned problem by providing an apparatus for implementing mouse function and scanner function alternatively wherein a portion of the input device of the scanner can be used as a mouse, and also the portion thereof can be used as a scanner by delivering the detected image to a computer which revises or compensates the shaking of the image or to other devices.

Further, the other object of the present invention is to provide a device that simplifies the task and improves efficiency by simultaneously realizing functions of a mouse and a scanner using input device having a region capable of scanning inclusive of region for detecting the transition of position, thereby reducing the size of an apparatus compared to a device using a mouse and scanner separately, being able to reduce a coupling terminal within the computer, reducing area of the scanner compared to the ordinary scanner, and being able to easily perform a scanning task in case document or image requires scanning task while using a mouse function.

In order to achieve the aforementioned object, the present invention provides an apparatus for implementing mouse function and scanner function alternatively, the apparatus comprising an input device for having a region capable of scanning including a position tracing region for detecting a transition of position of said apparatus; and an image processor for receiving an image data from said input device and storing, if a predetermined amount of said image data is collected, the image processor reading out the image data collected at said position tracing region and then detecting the transition of position of said apparatus, the image processor receiving user's selection with regard to any one of the mouse function or scanner function and transmitting corresponding information according to the selected function to the outside.

Preferably, the corresponding information is information with regard to the transition to X, Y axes concerning the position of said apparatus if the user selected the mouse function, and is information with regard to the transition to X, Y axes concerning the position of said apparatus and image data detected from the actual scanning region of said region capable of scanning if the user selected the scanner function.

More preferably, the image processor includes a selection button receiving input of user's selection with regard to any one of the mouse function or scanner function

More preferably, the position tracing region for detecting the transition of position among the region capable of scanning of said input device is positioned in a predetermined region of said region capable of scanning.

More preferably, the apparatus further comprises a pad indicated with grid for improving accuracy of the movement of the mouse function or scanning function of said apparatus.

More preferably, the apparatus further comprises a computer either for receiving the corresponding information from said image processor and moving pointer according to the information with regard to the transition of X, Y axes concerning the position of said apparatus or for compensating said image data by using information with regard to the transition of X, Y axes concerning the position of said apparatus.

In order to achieve the other object of the present invention, the present invention, in an apparatus for implementing mouse function and scanner function alternatively, provides a method for implementing mouse function and scanner function alternatively, the method comprising steps of (a) receiving user's selection with regard to any one of the mouse function or scanner function; (b) detecting a transition to X and Y axes concerning the position of said apparatus; (c) transmitting only the information with regard to the X and Y axes coordinate of the transition of position of said apparatus if said receipt of user's selection is the mouse function, transmitting an image data detected from the actual scanning region of a region capable of scanning of said apparatus together with the information with regard to the transition to X and Y axes concerning the position of said apparatus if said receipt of user's selection is the scanner function.

Preferably, step (b) includes steps of determining whether data with regard to a predetermined line or side generated by the input device are stored in a memory device and the position of said apparatus is detected from data stored in said memory device; performing repeatedly the step of storing data with regard to the predetermined line or side generated by said input device in said memory device if the position of said apparatus cannot be detected from data stored in said memory device; reading out a predetermined region from the stored data to obtain an image center or the image itself or obtaining and storing X, Y coordinates of a base point through spot of the surface if the position of said apparatus can be detected from data stored in said memory device; storing said data to the last predetermined line or side after data with regard to a predetermined line or side are generated by said input device, data with regard to the first predetermined line or side stored in said memory device are deleted, and the remaining stored data are moved to a direction of the first predetermined line or side; and determining the transition of position of said apparatus by obtaining an image center or the image itself from the stored data or by comparing X, Y coordinates of the base point obtained again through spot of the surface with the X, Y coordinates of the base point obtained previously.

More preferably, step (b) includes steps of detecting spot of the surface from reading each of the images consecutively through two regions of the transition of position of said input device while the user uses the scanning function, and indicating the transition of position of said spot in vector by detecting the transition of position of said detected spot; calculating the amount of straight line movement toward X axis direction or Y axis direction of the other end based on one end of said region of the transition of position by -deducting said vector, and calculating amount of rotation movement of said device by dividing the amount of straight line movement toward said Y axis direction by the amount of straight line movement toward said X axis direction.

More preferably, the predetermined region reading out from the data stored in said memory device is a polygon or region of a circle.

More preferably, the method further comprises a step of compensating said image data by a computer that shifts pointer in accordance with the information concerning the transition of position of said apparatus or by using information with regard to the transition of position of said apparatus, wherein said step of a computer compensating said image data includes steps of (d) initializing the related variables; (e) storing information concerning the transition of position of said apparatus inputted with a predetermined unit of line and said image data; (f) calculating speed of movement toward X axis direction by dividing distance moved toward X-axis direction by number of lines received, compensating image data toward X axis by compensating line compressively if said speed of movement is slow and by compensating line expansively if said movement speed is fast, compensating said image data toward Y axis direction by shifting as much as the transition of position of said image information compensated toward X axis direction is shifted toward Y axis direction, and storing image data compensated toward X, Y axes direction; (g) determining whether the scanning is completed; and (h) returning to step (e) if the scanning is not completed, and completing all processes if the scanning is completed.

### BRIEF DESCRIPTION OF THE DRAWINGS

Fig. 1 is a constitutional diagram of apparatus for implementing mouse function and scanner function alternatively according to the present invention.

FIG. 2 is a constitutional diagram of an input device of FIG. 1.

FIG. 3 is a flow chart showing the process of implementing scanner function and mouse function selectively according to the present invention.

FIG. 4 is a flow chart showing the process of detecting the transition of position to X, Y axes of the apparatus according to the present invention.

FIG. 5 is a diagram illustrating method of detecting the transition of position to X, Y axes from the memory device of the apparatus according to the present invention.

FIG. 6a to FIG. 6d are diagrams showing method of detecting the amount of rotation to X, Y direction of the apparatus according to the present invention.

FIG. 7 is a flow chart showing the process of compensating image regarding the transition of position of the apparatus according to the present invention.

### EMBODIMENTS

The preferred embodiments of the present invention are in detail explained referring to the drawings attached hereto.

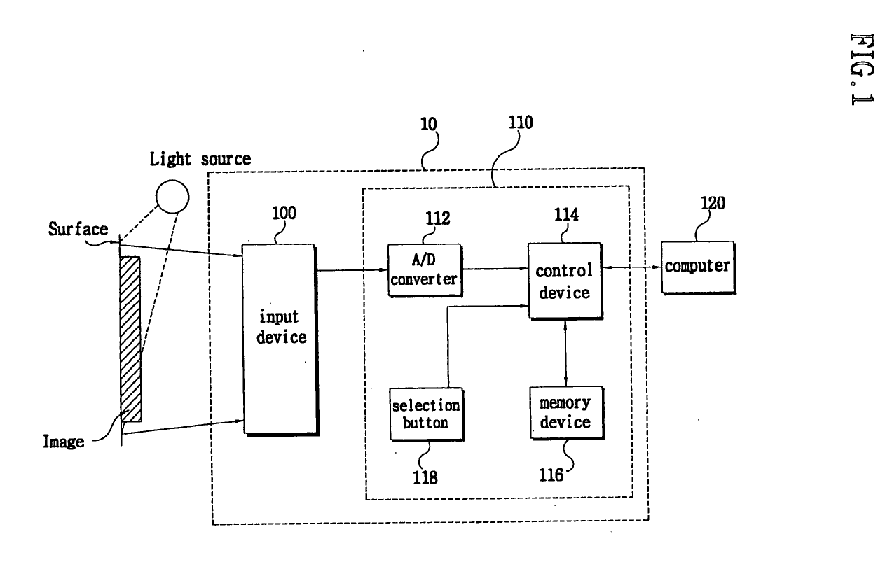

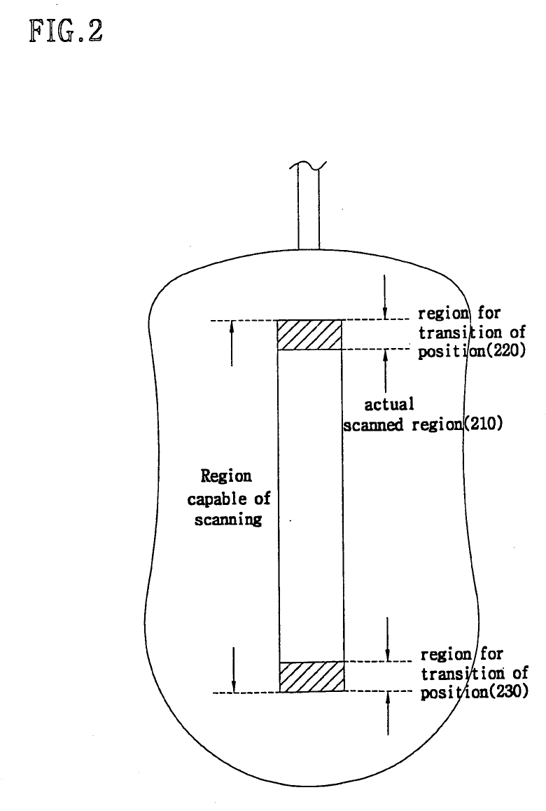

Fig.1 is a constitutional diagram of apparatus for implementing mouse function and scanner function alternatively according to the present invention, and FIG. 2 is a constitutional diagram of an input device of FIG. 1. FIG. 2 sets two position tracing regions (220 and 230) on both end portions of a region capable of scanning of an input device (100) to detect exactly the transition of position. However, one position tracing region may be set and its various modification is possible.

As shown in FIG. 1, the present apparatus (10) comprises largely two parts, i.e., input device (100) and image processor (110). The input device (100), as shown in FIG. 2, comprises image input device such as CCD, CIS that detects light reflected against the surface from light source for its change to voltage. Further, the input device (100) comprises position tracing regions (220 and 230) for detecting the transition of position of the present apparatus (100) and actual scanning region (210). As such, signals generated from the input device (100) are provided to the image processor (110).

The image processor (110) comprises analogue/digital (A/D) converter (112), control device (114), memory device (116) and selecting button (118).

The analogue/digital (A/D) converter (112) receives signals inputted from the input device (100) and converts the received signals to digital signals and provides the control device (114) with the digital signals. The selection button (118) receives the selection required by user between mouse function and scanner function and sends it to the control device (114).

The control device (114) stores a digital signal received from the A/D converter (112) in the memory device (114), if a predetermined amount of information is colleted in the memory device, reads image in the position tracing region (220 and 230) shown in FIG. 2 and detects the transition of position to X, Y axes of the present apparatus (10). Further, the control device receives a signal inputted in the selection button (118) to determine the selection of user, and transmits the detected transition of position to X, Y axes of the present apparatus (10) and image data detected from the actual scanning region (210) so as to be suitable for the function selected by user. At this time, a separate transmission device between the control device (114) and an external computer (120) can be installed and a USB port can be used as a transmission device.

In case where user selects mouse function through the selection button (118), the transmission device transmits only the information of the transition of position to X, Y axes of the present apparatus (10) to the computer (120). In case where user selects scanner function, the transmission device transmits image inputted in the actual scanning region (210) shown in FIG. 2 along with the information of the transition of position to X, Y axes of the present apparatus (10) detected from the image read by the position tracing region (220 and 230) to the computer (120).

In this case, the computer (120) is a device comprising software capable of moving a pointer of the computer (120) by using the information of the transition of position to X, Y axes of the present apparatus (10) inputted from the image processor (110), and capable of compensating image data inputted by using the information of the transition of position to X, Y axes of the present apparatus (10).

Further, the present apparatus (10) which implements mouse function and scanner function alternatively selects either scanner function or mouse function and performs a different operation according to said selection.

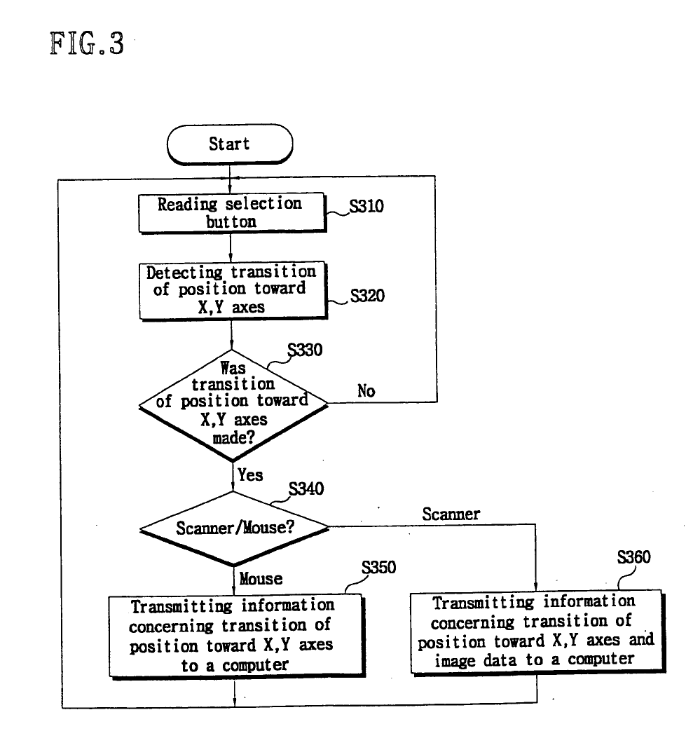

Referring to FIG. 3 to FIG. 5, a process of implementing mouse function and scanner function alternatively according to the present invention is explained.

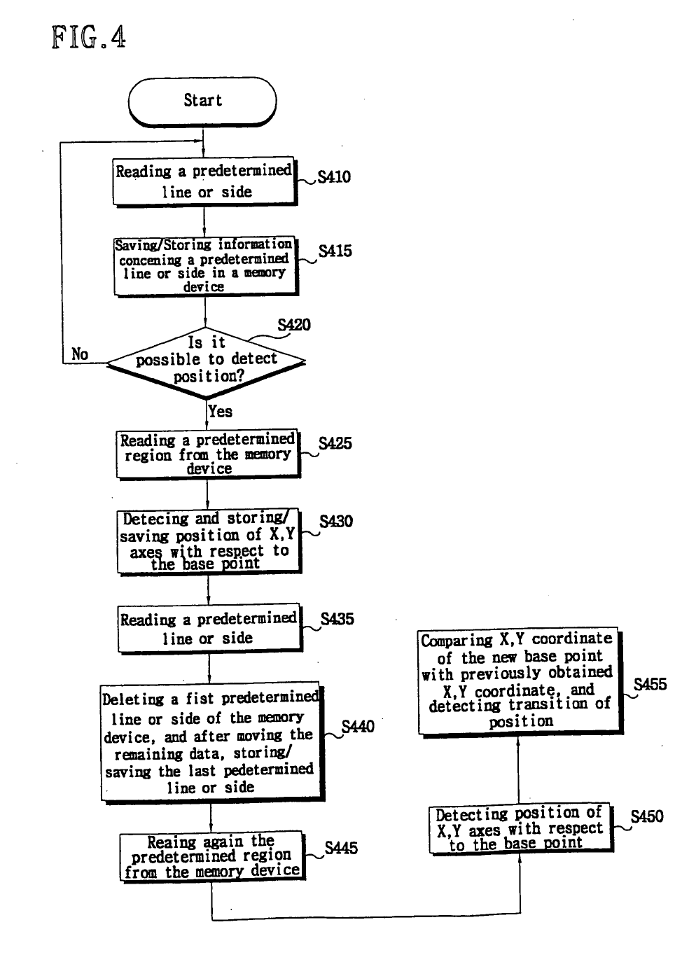

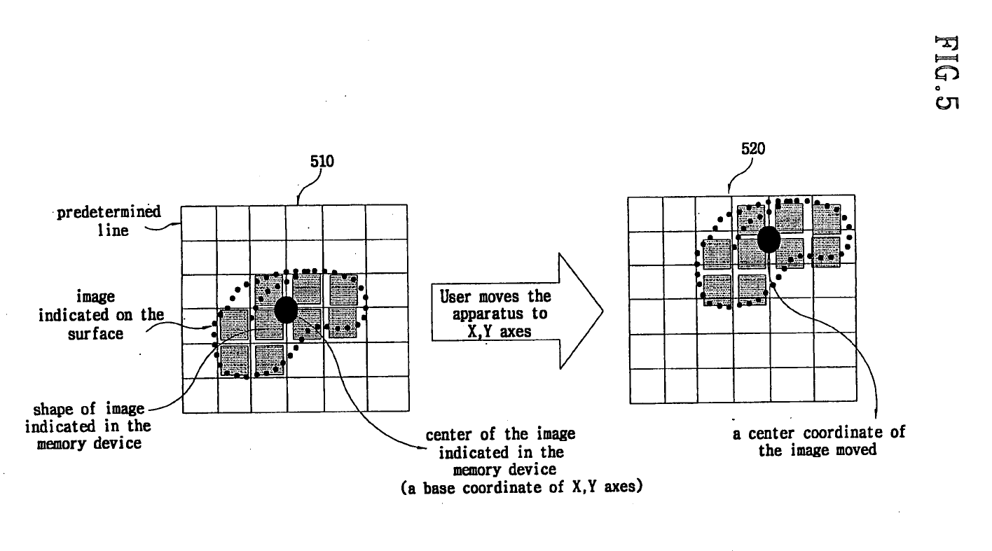

FIG. 3 is a flow chart showing the process of implementing scanner function and mouse function selectively according to the present invention FIG. 4 is a flow chart showing the process of detecting the transition of position to X, Y axes of the apparatus according to the present invention FIG. 5 is a diagram illustrating method of detecting the transition of position to X, Y axes from the memory device of the apparatus according to the present invention.

First, a selection between scanner function and mouse function is inputted from user (S310). Thereafter, the transition of position to x Y axes of the present apparatus (10) is detected (S320), and it is determined if the transition of position to X, Y axes occurs (S330). Such operation of detecting the transition of position to X, Y axes of the present apparatus (10) is shown in FIG. 4 and explained later.

In case where there is no transition of position to X, Y axes of the present apparatus (10), a selection between scanner function and mouse function is again inputted from user and then, the transition of position to X, Y axes of the present apparatus (10) is detected.

In case where there is the transition of position to X, Y axes of the present apparatus (10), the function inputted from user is determined (S340). In case where the function user inputted is mouse function, only the information of the transition of position to X, Y axes of the present apparatus (10) is transmitted to the computer (S350). In case where the function user inputted is scanner function, image data scanned from the actual scanning region (210) along with the information of the transition of position to X, Y axes of the present apparatus (10) is transmitted to the computer (120) (S350).

Such operation makes it possible to implement the present apparatus (10) as scanner and mouse alternatively, and to easily scan a necessary document or image when the present apparatus is implemented as mouse.

As described above, it is indispensable to detect the transition of position to X, Y axes of the present apparatus (10) to make the present apparatus (10) possible. Referring to FIG. 4, the operation of detecting the transition of position to X, Y axes of the present apparatus (10) is explained.

First, the input device (100) generates data regarding a predetermined line or side. Data generated by the input device is stored in the memory device (116) (S415). Thereafter, it is determined if the position of the present apparatus (10) can be detected from data stored in the memory device (116) (S420). In case of not detecting the position of the apparatus (10) from data stored in the memory device (116), a step of storing data regarding the predetermined line or side generated by said input device in the memory device is repeatedly performed.

In case of detecting the position of the apparatus (10) from data stored in the memory device (116), as shown in FIG. 5, a predetermined region reads from data stored in the memory device (S425), and an image core or image itself (510) in the surface of the predetermined region is obtained, or X, Y coordinate of a reference point is obtained for storage thereof through spot generated in the surface (S430).

Thereafter, the input device (100) generates again data regarding a predetermined line or side (S435), data regarding a first predetermined line or side in data stored in the memory device (116) are deleted and the remaining stored data is moved to the direction of the first predetermined line or side, before storing data in a last predetermined line or side (S440).

A predetermined region reads again from data stored in the memory device (116) (S445), and an image core or image itself (520) in the surface of the predetermined region is obtained, or X, Y coordinate of a reference point is again obtained through spot generated in the s=surface (S450). Thereafter, newly obtained X, Y coordinate of a reference point is compared with formerly obtained X, Y coordinates of a reference point to detect the transition of position to X, Y axes of the present apparatus (10) (S455).

Such method enables to obtain the transition of position to X, Y axes of the present apparatus (10), and the obtained information of the transition of position to x, Y axes of the present apparatus (10) is used for the computer (120) to shift a pointer of mouse to where user wants or to compensate the scanned image in the actual scanning region (210) of the input device (100).

At this time, in case of using the present apparatus (10) along with a pad wherein grid is indicated, the grid which is indicated in the pad can be used as a reference point in obtaining the transition of position to X, Y axes of the present apparatus (10), which improves accuracy in operating mouse function or scanning function of the present apparatus (10).

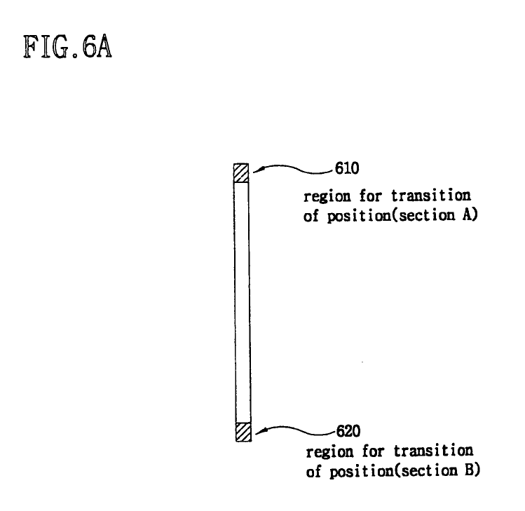

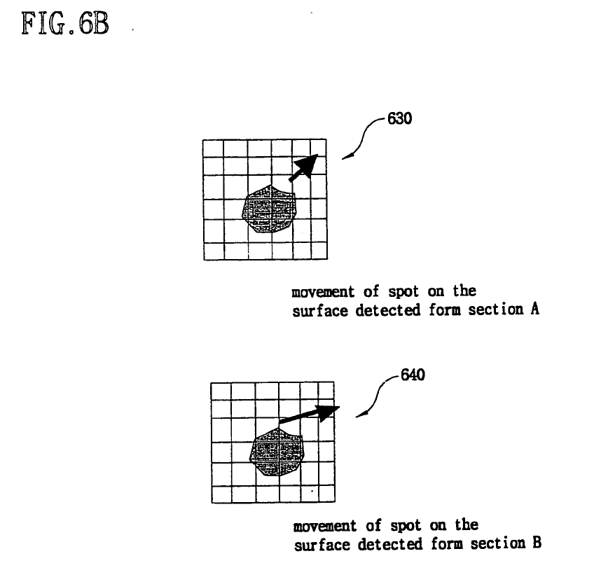

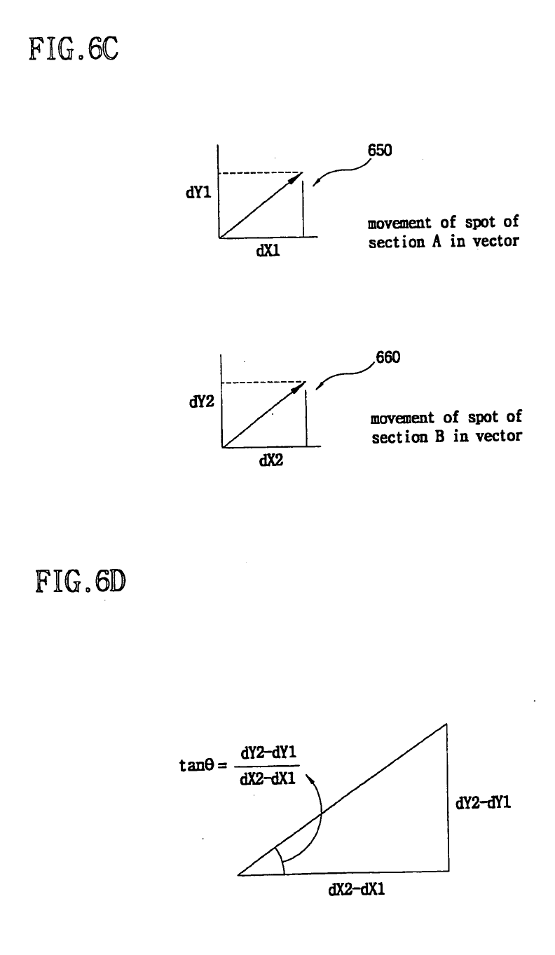

Setting two position tracing regions (220 and 230) in the input device (100) enables to measure the amount of rotation of the present apparatus (10) through the transition of position to X, Y axes of the present apparatus (10). A method of measuring the amount of rotation of the present apparatus (10) is explained hereinafter referring to FIG. 6a to 6d.

FIG. 6a shows the position tracing regions (610 and 620) which were set up in the input device of the present apparatus (10), and FIG. 6d shows image consecutively read out by the control device (1 14) through the position tracing regions (610 and 620) of the input device while user uses the scanner function of the present apparatus (10). Further, FIG. 6c, after detecting the transition of position of each spot through the spot of surface appeared on the image read out from both sides of the present apparatus (10), shows the detected transition of position of each spot in a vector. FIG. 6d shows the relative motion of B part on the basis of A part in a forward movement and rotation movement.

First, while user uses the scanner function, images are consecutively read out through two position tracing regions (610 and 620) of the input device to detect the spot of surface (630 and 640). The transition of position of the detected spot (630 and 640) is detected to express the transition of position of said spot in a vector (650 and 660).

Thereafter, the amount of forward movement to X direction or Y direction of the other end on the basis of one end of the position tracing regions (610 and 620) is calculated by subtracting the vector obtained above.

At this time, the forward movement to X direction is dX₂−dX₁, and the forward movement to Y direction can be expressed dY₂−dY₁. Dividing the amount of the forward movement to Y direction by the amount of the forward movement to X direction enables to obtain the amount of the rotation movement of the present apparatus. In this regard, the amount of the rotation movement of the present apparatus (10) is expressed in the following equation:
tan θ=(dY₂−dY₁)/(dX₂−dX₁) [Equation 1]

The amount of the rotation movement of the present apparatus (10) according to the above motion can be utilized for the computer (120) in compensating the image data.

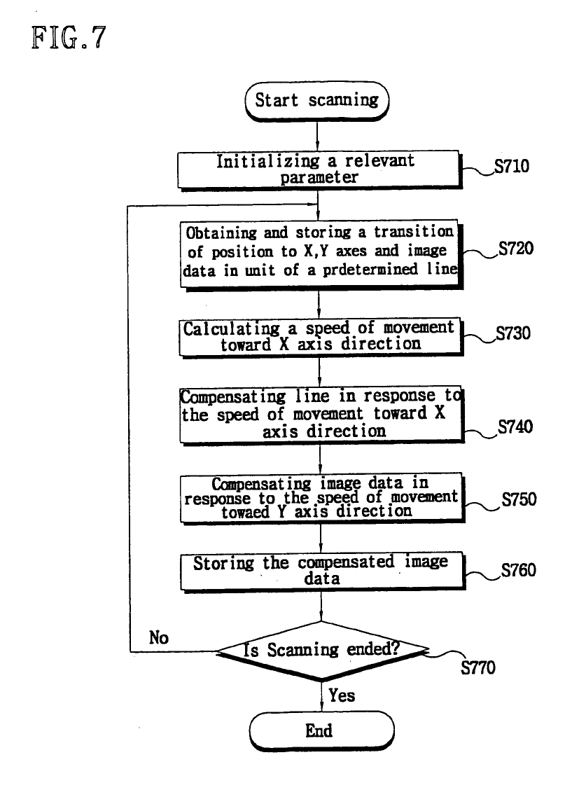

The image transferred to the computer (120) by the present apparatus (10) can be compensated on the basis of the transition of position to X, Y axes of the present apparatus (1o). Hereinafter, the motion of compensating image according to such transition of position to X, Y axes is explained referring to FIG. 7.

FIG. 7 is a flow chart showing the process of compensating image regarding the transition of position of the apparatus according to the present invention.

First, a relevant parameter is initialized at the point of starting receiving image (S710). After initialization, information of the transition of position to X, Y axes of the present apparatus (10) that was obtained from the position tracing region of the input device (100) and image data collected from the actual scanning region of the input device (100) are stored in unit of a predetermined line (S720). Thereafter, speed of movement toward X axis direction of the present apparatus (10) is calculated (S730). The speed (V) of movement toward X axis direction is expressed in Equation 2 below:
V=ΔX/ΔN [Equation 2]

ΔX is the distance of movement toward X axis direction, and ΔN is the number of received lines.

At this time, in the case user has the present apparatus (10) moved slowly, the number of received lines increases. In the case user has the present apparatus (10) moved fast, the number of received lines regarding the same distance of movement toward X axis direction decreases.

As such, in order to compensate different number of lines according to speed of movement of the present apparatus (10), line is compensated in response to the speed of movement of the present apparatus (10) (S740). At this time, in the case speed of movement of the device user performs is slow, line is compressed and compensated. In the case speed of movement of the device user performs is fast, line is expanded and compensated. For the present apparatus (10), speed of reading image is fast enough to calculate speed of movement regarding user's fast motion.

Thereafter, the corrected image toward X axis direction is compensated for Y axis direction again in the same manner (S750). The correction toward X axis direction concerns vibration that could be occurred when user has the present apparatus (10) moved, and thus is made by simply shifting as much as image data transits position thereof toward Y axis direction. Finally, all compensated image data to X, Y axes direction as described above are stored (S760).

Thereafter, it determines if the scanning ends (S770). If the scanning does not end, the above process repeats until the scanning ends. If the scanning ends, image compensating motion ends.

If necessary, the compensated image information as above is printed out through a printing device such as a monitor or printer, or can be utilized in OCR (Optical Character Reader).

### INDUSTRIAL APPLICABLITY

The present invention can be utilized as a mouse by using a part of region of the input device of a scanner, and as a scanner by transferring the detected image to a computer or other device capable of compensating the image, thus implementing mouse function and scanner function alternatively.

Further, the present invention embodies mouse function and scanner function alternatively by using an input device having a region capable of scanning including a position tracing region, resulting in reduction in size of the device, and can perform a convenient scanning operation when the scanning operation is necessary while using mouse function.

As described above, the apparatus according to the present invention is constituted in a single device of a scanner and mouse. Hence, while the device is used as a mouse, in the case there is a necessary part in a book, name card, or note, the corresponding image or text can be conveniently scanned using the same device without using other device, thereby reducing size of the device and improving convenience and efficiency of the operation in comparison with each use of a mouse and scanner.

1. An apparatus for implementing mouse function and scanner function alternatively, the apparatus comprising:
an input device for having a region capable of scanning including a position tracing region for detecting a transition of position of said apparatus; and
an image processor for receiving an image data from said input device and storing, if a predetermined amount of said image data is collected, the image processor reading out the image data collected at said position tracing region and then detecting the transition of position of said apparatus, the image processor receiving user's selection with regard to any one of the mouse function or scanner function and transmitting corresponding information according to the selected function to the outside.

2. The apparatus according to claim 1, wherein said corresponding information is information with regard to the transition to X, Y axes concerning the position of said apparatus if the user selected the mouse function, and is information with regard to the transition to X, Y axes concerning the position of said apparatus and image data detected from the actual scanning region of said region capable of scanning if the user selected the scanner function.

3. The apparatus according to claim 1, wherein said image processor includes a selection button receiving input of user's selection with regard to any one of the mouse function or scanner function.

4. The apparatus according to claim 1, wherein said position tracing region for detecting the transition of position among the region capable of scanning of said input device is positioned in a predetermined region of said region capable of scanning.

5. The apparatus according to claim 1, further comprising a pad indicated with grid for improving accuracy of the movement of the mouse function or scanning function of said apparatus.

6. The apparatus according to claim 2 further comprising a computer either for receiving the corresponding information from said image processor and moving pointer according to the information with regard to the transition of X, Y axes concerning the position of said apparatus or for compensating said image data by using information with regard to the transition of X, Y axes concerning the position of said apparatus.

7. In an apparatus for implementing mouse function and scanner function alternatively, a method for implementing mouse function and scanner function alternatively, the method comprising:
(a) receiving user's selection with regard to any one of the mouse function or scanner function;
(b) detecting a transition to X and Y axes concerning the position of said apparatus; and
(c) transmitting only the information with regard to the X and Y axes coordinate of the transition of position of said apparatus if said receipt of user's selection is the mouse function, transmitting an image data detected from the actual scanning region of a region capable of scanning of said apparatus together with the information with regard to the transition to X and Y axes concerning the position of said apparatus if said receipt of user's selection is the scanner function.

8. The method according to claim 7, said step (b) includes steps of:
determining whether data with regard to a predetermined line or side generated by the input device are stored in a memory device and the position of said apparatus is detected from data stored in said memory device;
performing repeatedly the step of storing data with regard to the predetermined line or side generated by said input device in said memory device if the position of said apparatus cannot be detected from data stored in said memory device; reading out a predetermined region from the stored data to obtain an image center or the image itself or obtaining and storing X, Y coordinates of a base point through spot of the surface if the position of said apparatus can be detected from data stored in said memory device;
storing said data to the last predetermined line or side after data with regard to a predetermined line or side are generated by said input device, data with regard to the first predetermined line or side stored in said memory device are deleted, and the remaining stored data are moved to a direction of the first predetermined line or side; and
determining the transition of position of said apparatus by obtaining an image center or the image itself from the stored data or by comparing X, Y coordinates of the base point obtained again through spot of the surface with the X, Y coordinates of the base point obtained previously.

9. The method according to claim 7, said step (b) includes steps of:
detecting spot of the surface from reading each of the images consecutively through two regions of the transition of position of said input device while the user uses the scanning function, and indicating the transition of position of said spot in vector by detecting the transition of position of said detected spot;
calculating the amount of straight line movement toward X axis direction or Y axis direction of the other end based on one end of said region of the transition of position by deducting said vector; and calculating amount of rotation movement of said device by dividing the amount of straight line movement toward said Y axis direction by the amount of straight line movement toward said X axis direction.

10. The method according to claim 8, wherein the predetermined region reading out from the data stored in said memory device is a polygon or region of a circle.

11. The method according to claim 7, further comprising a step of compensating said image data by a computer that shifts pointer in accordance with the information concerning the transition of position of said apparatus or by using information with regard to the transition of position of said apparatus, wherein said step of a computer compensating said image data includes steps of
(d) initializing the related variables;
(e) storing information concerning the transition of position of said apparatus inputted with a predetermined unit of line and said image data;
(f) calculating speed of movement toward X axis direction by dividing distance moved toward X-axis direction by number of lines received, compensating image data toward X axis by compensating line compressively if said speed of movement is slow and by compensating line expansively if said movement speed is fast, compensating said image data toward Y axis direction by shifting as much as the transition of position of said image information compensated toward X axis direction is shifted toward Y axis direction, and storing image data compensated toward X,Y axes direction;
(g) determining whether the scanning is completed; and
(h) returning to step (e) if the scanning is not completed, and completing all of the movement if the scanning is completed.
